(19) United States
(12) Patent Application Publication
(10) Pub. No.: US 2026/0038905 A1
(43) Pub. Date: Feb. 5, 2026

(54) COOLING SYSTEM

(71) Applicant: MAZDA MOTOR CORPORATION, Hiroshima (JP)

(72) Inventors: Kentaro KAWAGUCHI, Aki-gun (JP); Yuma MIYAUCHI, Aki-gun (JP)

(73) Assignee: MAZDA MOTOR CORPORATION, Hiroshima (JP)

(21) Appl. No.: 19/280,332

(22) Filed: Jul. 25, 2025

(30) Foreign Application Priority Data
Jul. 31, 2024 (JP) 2024-124222

(51) Int. Cl. H01M 10/613; B60H 1/00; B60H 1/32; H01M 10/625; H01M 10/633; H01M 10/663

(52) U.S. Cl. CPC H01M 10/613; B60H 1/00278; B60H 1/00392; B60H 1/32281; H01M 10/625; H01M 10/633; H01M 10/663; B60H 2001/3255; B60H 2001/3285

(57) ABSTRACT

A cooling system includes a compressor that compresses a refrigerant in two stages using first and second compressors, a heat exchanger that cools the refrigerant from the compressor, heat exchangers that use the refrigerant from the heat exchanger, a refrigerant passage that supplies the refrigerant from the heat exchanger to a battery and supplies this refrigerant to the first compressor, refrigerant passages that supply the refrigerant from the heat exchangers to the second compressor, an expansion valve provided on the refrigerant passage, and an expansion valve provided on the refrigerant passage, and a control device performs control to increase the opening degree of the expansion valve when the temperature of the refrigerant discharged from the second compressor is equal to or higher than a predetermined temperature.

### CROSS-REFERENCE TO RELATED APPLICATION

This application claims priority under 35 U.S.C. § 119(a) to Application No. 2024-124222, filed in Japan on Jul. 31, 2024, the entire contents of which is hereby incorporated by reference into the present application.

### TECHNICAL FIELD

One or more embodiments of the present disclosure relate to a cooling system that performs cooling inside a vehicle by circulating a refrigerant containing CO₂.

A system that circulates a refrigerant through a compressor and a heat exchanger has been conventionally used in a refrigeration cycle used in an air conditioner. In addition, in recent years, such a system that circulates a refrigerant has also been used to cool a component inside a vehicle, for example, to cool a battery of an electric vehicle or a hybrid vehicle. In one example, Patent Literature 1 describes a system that cools and heats a battery cell by connecting a compressor, a first heat exchanger, and a second heat exchanger through a refrigerant channel and performing heat exchange between a refrigerant and the battery cell using the second heat exchanger.

### SUMMARY OF DISCLOSURE

In recent years, there has been a growing requirement for cooling batteries due to quicker charging and higher power output of batteries, and a battery cooling technique using, for example, a cooling water that has insulating properties and can directly cool the inside of a battery has been developed. In such a battery cooling technique using a coolant or the like, while high cooling capability can be expected, pressure loss caused by the viscosity of oil occurs. In response to this, the present inventors considered using a refrigerant containing CO₂, the refrigerant having insulating properties and low viscosity (hereinbelow, referred to as the “CO₂ refrigerant” as appropriate), to efficiently cool a battery while reducing pressure loss. Since such a CO₂ refrigerant is a so-called natural refrigerant, influences on environment and the human body are also taken into consideration.

Here, when the battery is cooled using the CO₂ refrigerant, typically, the CO₂ refrigerant that has been brought to high pressure by a compressor may be largely decompressed by an expansion valve and supplied to the battery. This is because it is not desirable to supply the high-pressure CO₂ refrigerant as it is to the battery in some cases. For example, it is not desirable to supply the high-pressure CO₂ refrigerant to a plurality of cells inside the battery.

After the CO₂ refrigerant largely decompressed by the expansion valve as described above is used for cooling of the battery, the CO₂ refrigerant is returned to the compressor; in this case, the compressor largely raise the pressure of the CO₂ refrigerant having a considerably low pressure. As a result, the CO₂ refrigerant discharged from the compressor becomes high temperature. This causes oil in the CO₂ refrigerant to stop functioning, thereby causing seizure of a sliding surface, a reduction in the sealability, or deterioration of the oil.

The one or more embodiments have been made to solve the problems in the conventional technique described above, and an object thereof is, in a cooling system that cools a battery or the like inside a vehicle by circulating a refrigerant containing CO₂, to restrain the refrigerant from becoming high temperature by being raised in pressure by a compressor.

### Means for Solving the Problems

In order to achieve the above-mentioned object, the one or more embodiments include a cooling system that performs cooling inside a vehicle by circulating a refrigerant containing CO₂, the cooling system including: a compressor including a first compressor and a second compressor provided downstream of the first compressor, the compressor being configured to compress the refrigerant in two stages using the first compressor and the second compressor; a first heat exchanger for cooling the refrigerant compressed by the compressor; a second heat exchanger for cooling a predetermined cooling target inside the vehicle using the refrigerant cooled by the first heat exchanger; a first refrigerant passage for supplying the refrigerant to a battery inside the vehicle to cool the battery using the refrigerant cooled by the first heat exchanger and supplying the refrigerant that has been used for cooling in the battery to the first compressor of the compressor; a second refrigerant passage for supplying the refrigerant that has been used for cooling in the second heat exchanger to the second compressor of the compressor; a first expansion valve for expanding the refrigerant, the first expansion valve being provided on the first refrigerant passage; a second expansion valve for expanding the refrigerant, the second expansion valve being provided on the second refrigerant passage; and a control device configured to control at least the first expansion valve and the second expansion valve, characterized in that the control device is configured to obtain a temperature of the refrigerant discharged from the second compressor of the compressor, and perform control to increase an opening degree of the second expansion valve when the temperature is equal to or higher than a predetermined temperature.

According to the one or more embodiments configured in this manner, the compressor is configured to raise the pressure of the refrigerant in two stages using the first and second compressors, and, while the first compressor on the upstream side is supplied with the refrigerant decompressed by the first expansion valve, the second compressor on the downstream side is supplied with the refrigerant that is a mixture of the refrigerant discharged from the first compressor with the refrigerant in a relatively low enthalpy state decompressed by the second expansion valve (that is, the refrigerant having a lower enthalpy than the refrigerant that has been raised in pressure by the first compressor described above), thereby making it possible to restrain the refrigerant that has been raised in pressure by the second compressor from becoming high temperature. In particular, in the one or more embodiments, when the temperature of the refrigerant discharged from the second compressor is equal to or higher than the predetermined temperature, the temperature of the refrigerant is made lower than the predetermined temperature by performing control to increase the opening degree of the second expansion valve (in other words, the opening degree of the second expansion valve is not increased when the temperature of the refrigerant is lower than the predetermined temperature) to increase the amount of the refrigerant supplied from the second refrigerant passage to the second compressor. Accordingly, it is possible to appropriately lower the temperature of the refrigerant discharged from the second compressor while restraining the reduction in the efficiency of the cooling system. As a result, it is possible to maintain the function of oil in the refrigerant and restrain deterioration of the oil.

In the one or more embodiments, preferably, the control device is configured to perform control to reduce an opening degree of the first expansion valve when the temperature of the refrigerant discharged from the second compressor is equal to or higher than the predetermined temperature and the second expansion valve is fully open.

According to the one or more embodiments configured in this manner, by narrowing the first expansion valve on the first refrigerant passage, it is possible to increase the amount of the refrigerant flowing through the second refrigerant passage and ensure the amount of the refrigerant supplied from the second refrigerant passage to the second compressor. Thus, according to the one or more embodiments, it is possible to appropriately lower the temperature of the refrigerant discharged from the second compressor even when the second expansion valve becomes a fully open state.

In the one or more embodiments, preferably, the cooling system further includes a battery heat exchanger for directly cooling a plurality of cells inside the battery using the refrigerant by passing the refrigerant in the first refrigerant passage around the plurality of cells, and the battery heat exchanger is supplied with the refrigerant decompressed by the expansion valve.

According to the one or more embodiments configured in this manner, since the plurality of cells are directly cooled using the refrigerant in the battery heat exchanger, it is possible to effectively cool the plurality of cells. In this case, since it is not desirable to supply the high-pressure refrigerant from the compressor as it is to the battery heat exchanger because the pressure resistance of a battery pack and the like is relatively low, the refrigerant from the compressor is decompressed by the first expansion valve and supplied to the battery heat exchanger in the one or more embodiments. Accordingly, it is possible to properly protect the inside of the battery (such as the plurality of cells).

In the one or more embodiments, preferably, the second heat exchanger includes an air conditioning heat exchanger for performing air conditioning of the vehicle and/or a battery heat exchanger for indirectly cooling a plurality of cells using the refrigerant by supplying the refrigerant to outside of a battery pack including the plurality of cells in the battery.

According to the one or more embodiments configured in this manner, one system (cooling system) that circulates the refrigerant can appropriately achieve air conditioning of the vehicle and cooling of the battery. In particular, by using the battery heat exchanger that supplies the refrigerant to the outside of the battery pack, it is possible to appropriately cool the battery and achieve relatively large heat exchange with the refrigerant.

In the one or more embodiments, preferably, the first heat exchanger is configured as a cascade heat exchanger that performs heat exchange between a first heat cycle circuit including at least the compressor, the second heat exchanger, the first and second refrigerant passages, and the first and second expansion valves and a second heat cycle circuit including an outside air heat exchanger that exchanges heat with outside air separately from the first heat cycle circuit.

According to the one or more embodiments configured in this manner, by causing the first heat cycle circuit to perform heat exchange (cascade heat exchange) with the second heat cycle circuit that exchanges heat with the outside air, it is possible to improve the efficiency of the entire system of the first heat cycle circuit, in other words, reduce the work of the compressor inside the first heat cycle circuit.

In the one or more embodiments, preferably, the cooling system is configured to further cool, using the refrigerant cooled by the first heat exchanger, a motor that drives the vehicle using electric power of the battery.

According to the one or more embodiments configured in this manner, one system (cooling system) that circulates the refrigerant can appropriately achieve cooling of various components inside the vehicle, such as the motor.

In the one or more embodiments, preferably, the refrigerant that has been used for cooling in the motor is further supplied to the second refrigerant passage. According to the one or more embodiments configured in this manner, the refrigerant in a relatively low enthalpy state from the motor can be supplied to the second compressor. In this case, although the enthalpy of the refrigerant supplied from the second refrigerant passage to the second compressor changes due to the cooling requirement of the motor and the like, in the one or more embodiments, as described above, since the temperature of the refrigerant discharged from the second compressor is monitored, and the opening degree of the second expansion valve is controlled in accordance with this temperature, the influence of the change in the enthalpy of the refrigerant caused by the cooling requirement of the motor and the like can be reduced.

### Advantageous Effects of Invention

According to the one or more embodiments, in a cooling system that cools a battery or the like inside a vehicle by circulating a refrigerant containing CO₂, it is possible to restrain the refrigerant from becoming high temperature by being raised in pressure by a compressor.

### BRIEF DESCRIPTION OF DRAWINGS

FIG. 1 is a schematic configuration diagram of a vehicle to which a cooling system according to one or more embodiments is applied.

FIG. 2 is a schematic configuration diagram of the cooling system according to the one or more embodiments.

(a) of FIG. 3 and (b) of FIG. 3 are schematic configuration diagrams of a first battery heat exchanger and a second battery heat exchanger according to the one or more embodiments, respectively.

FIG. 4 is a block diagram showing an electrical configuration of the cooling system according to the one or more embodiments.

FIG. 5 is an explanatory diagram regarding a basic concept of control according to the one or more embodiments.

FIG. 6 is a flowchart showing the control according to the one or more embodiments.

Hereinbelow, a cooling system according to an embodiment of the present invention will be described with reference to the accompanying drawings.

### Entire Configuration

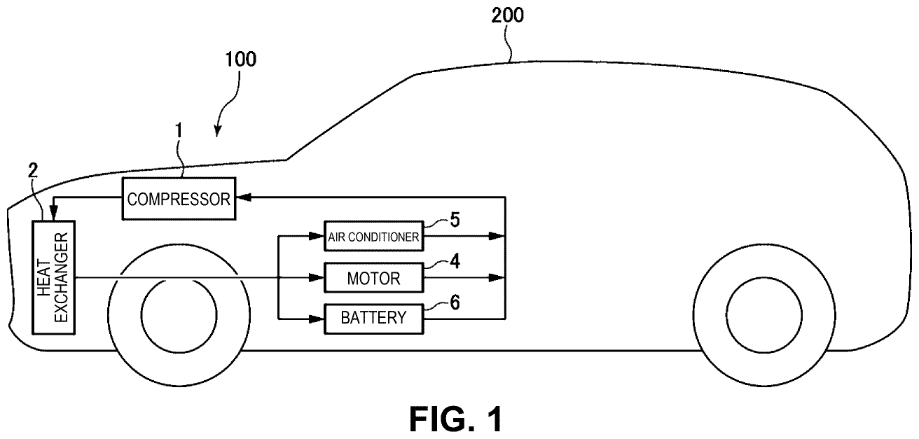

First, the entire configuration of the cooling system according to the one or more embodiments will be described with reference to FIG. 1. FIG. 1 is a schematic configuration diagram of a vehicle to which the cooling system according to the present embodiment is applied.

As shown in FIG. 1, a vehicle 200 is, for example, an electric vehicle, and includes a cooling system 100 that circulates a refrigerant in a refrigeration cycle. The cooling system 100 mainly includes a compressor 1 for compressing the refrigerant, a heat exchanger 2 for cooling the refrigerant compressed by the compressor 1, a motor (e.g., electric motor) 4 for generating power to drive the vehicle 200, an air conditioner 5 that performs air conditioning inside the vehicle 200, and a battery 6 that supplies electric power to drive the motor 4.

The cooling system 100 circulates a CO₂ refrigerant (hereinbelow, may be simply referred to as the “refrigerant”) as a natural refrigerant. Typically, the CO₂ refrigerant is a refrigerant containing CO₂, a refrigerating machine oil (e.g., oil), such as Polyalkylene Glycol (PAG), and an additive to perform lubrication and sealing of various devices inside the cooling system 100. Since such a CO₂ refrigerant is used, the compressor 1 is configured to compress the refrigerant to an extremely high pressure. The motor 4 uses the refrigerant (e.g., in a liquid state (typically, in a supercritical state)) compressed by the compressor 1 in this manner for cooling of a rotor and a stator. In addition, the motor 4 is configured to also use the refrigerant for lubrication of a sliding bearing that supports a rotation shaft. In addition, the refrigerant compressed by the compressor 1 is used for air conditioning in the air conditioner 5 and cooling of the battery 6. For example, in the cooling system 100, the high-temperature and high-pressure gas refrigerant is supplied from the compressor 1 to the heat exchanger 2, the low-temperature and high-pressure liquid refrigerant is supplied from the heat exchanger 2 to the motor 4 and the like, and the normal-temperature and low-pressure gas refrigerant is supplied from the motor 4 and the like to the compressor 1.

### Configuration of Cooling System

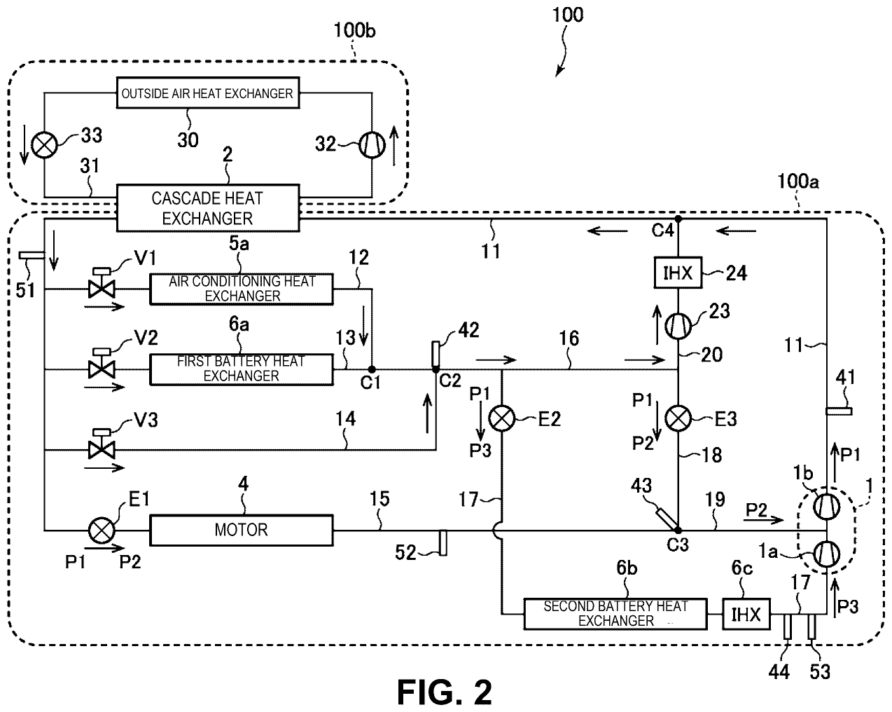

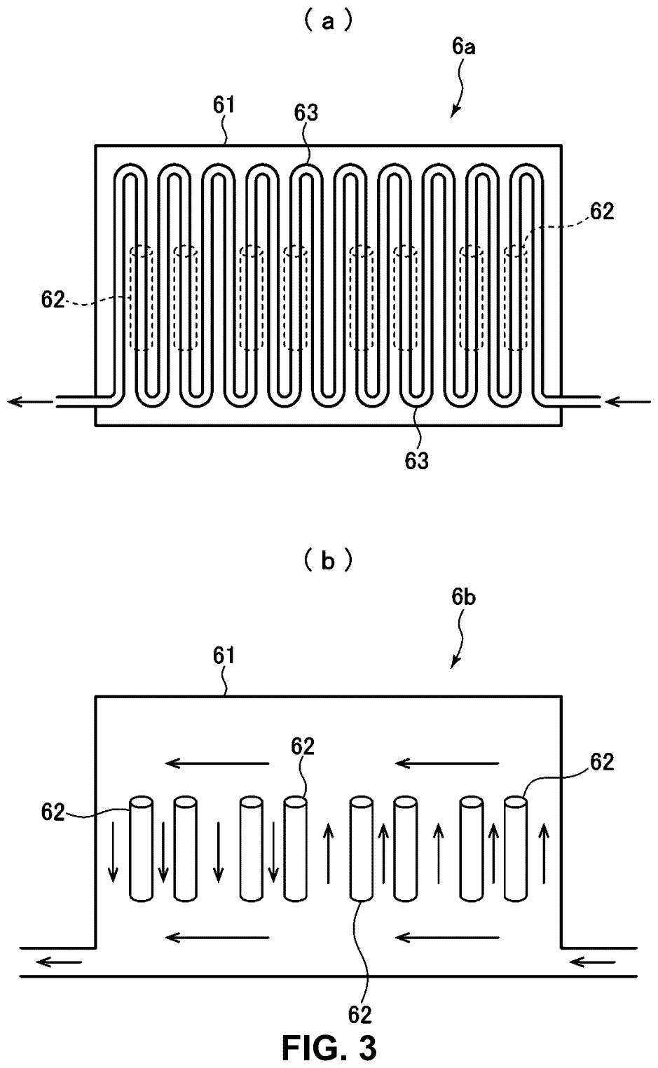

Next, the cooling system 100 according to the one or more embodiments will be specifically described with reference to FIG. 2. FIG. 2 is a schematic configuration diagram of the cooling system 100 according to the one or more embodiments.

As shown in FIG. 2, the cooling system 100 includes a first heat cycle circuit (e.g., low-temperature circuit) 100a that circulates the above-mentioned CO₂ refrigerant, and a second heat cycle circuit (e.g., high-temperature circuit) 100b that includes an outside air heat exchanger 30 that exchanges heat with outside air and circulates a refrigerant such as propane or a fluorine-based refrigerant, and is configured to achieve a cascade refrigeration cycle. Specifically, the first heat cycle circuit 100a and the second heat cycle circuit 100b perform cascade heat exchange in the heat exchanger 2 (hereinbelow, the heat exchanger 2 is referred to as the “cascade heat exchanger 2” as appropriate). The cascade heat exchanger 2 corresponds to the “first heat exchanger” in the one or more embodiments.

The first heat cycle circuit 100a of the cooling system 100 mainly includes, in addition to the compressor 1 and the motor 4 described above, an air conditioning heat exchanger 5a for performing heat exchange in the air conditioner 5 (e.g., specifically, an evaporator that generates cold air to be supplied to the inside of the vehicle), a first battery heat exchanger 6a and a second battery heat exchanger 6b that perform heat exchange to cool the battery 6, refrigerant passages 11 to 20 through which the refrigerant flows, a pressure feeder 23 that pressure-feeds the refrigerant, flow control valves V1, V2, V3 that adjust the flow rate of the refrigerant, and expansion valves E1, E2, E3 that expand and decompress the refrigerant.

In the one or more embodiments, the compressor 1 includes a first compressor 1a on the upstream side and a second compressor 1b on the downstream side, and is configured to compress the refrigerant in two stages. The first compressor 1a increases a pressure P3 of the refrigerant to a pressure P2 (e.g., the pressure P2>the pressure P3), and the second compressor 1b increases the pressure P2 of the refrigerant to a pressure P1 (e.g., the pressure P1>the pressure P2). In one example, the pressure P1 is approximately 3 MPa, the pressure P2 is approximately 1.5 MPa, and the pressure P3 is approximately 0.1 MPa.

In addition, in the one or more embodiments, the battery 6 is configured to be cooled by two heat exchangers, that is, the first battery heat exchanger 6a and the second battery heat exchanger 6b. The configuration of the first battery heat exchanger 6a and the second battery heat exchanger 6b will be described with reference to (a) of FIG. 3 and (b) of FIG. 3. (a) of FIG. 3 and (b) of FIG. 3 schematically show examples of the first battery heat exchanger 6a and the second battery heat exchangers 6b, respectively. More specifically, (a) of FIG. 3 is a plan view of a battery pack 61 of the battery 6 viewed from the outside, and (b) of FIG. 3 is a plan perspective view of the inside of the battery pack 61.

As shown in (a) of FIG. 3, the first battery heat exchanger 6a is configured to indirectly cool a plurality of cells 62 inside the battery 6 using the refrigerant by suppling the refrigerant to the outside of the battery pack 61 (typically, the surface of a case) including the plurality of cells 62 in the battery 6, more specifically, by passing the refrigerant through a channel 63 that is formed in a meandering manner. Note that the configuration that indirectly cools the cells 62 inside the battery 6 using the refrigerant is not limited to the configuration shown in (a) of FIG. 3, and various known configurations can be adopted. On the other hand, as shown in (b) of FIG. 3, the second battery heat exchanger 6b is configured to directly cool the plurality of cells 62 using the refrigerant by passing the refrigerant around the plurality of cells 62 inside the battery 6, that is, by passing the refrigerant inside the battery pack 61. Note that the first battery heat exchanger 6a and the air conditioning heat exchanger 5a described above correspond to the “second heat exchanger” in the one or more embodiments. In this case, the air conditioning heat exchanger 5a cools the evaporator (e.g., cooling target) of the air conditioner 5 using the refrigerant, and the first battery heat exchanger 6a cools the battery 6 (e.g., cooling target) using the refrigerant.

Referring back to FIG. 2, the flow of the refrigerant inside the first heat cycle circuit 100a will be specifically described. The refrigerant compressed by the compressor 1 is supplied from the refrigerant passage 11 to the cascade heat exchanger 2, and the refrigerant cooled by the cascade heat exchanger 2 is supplied from the refrigerant passages 12, 13, 15 connected to the refrigerant passage 11 to the air conditioning heat exchanger 5a, the first battery heat exchanger 6a, and the motor 4, respectively. The refrigerant passage 12 and the refrigerant passage 13 join at a confluence C1 and are connected to the refrigerant passage 16, which causes the refrigerant that has exchanged heat in the air conditioning heat exchanger 5a and the refrigerant that has exchanged heat in the first battery heat exchanger 6a to be supplied to the refrigerant passage 16. In addition, the refrigerant cooled by the cascade heat exchanger 2 is directly supplied to the refrigerant passage 16 through the refrigerant passage 14 that is connected to the refrigerant passage 11, without passing through the air conditioning heat exchanger 5a and the first battery heat exchanger 6a (that is, bypassing the refrigerant passages 12, 13, 15). In this case, the refrigerant passage 14 and the refrigerant passage 16 join at a confluence C2 that is downstream of the confluence C1 described above. In addition, the refrigerant passages 12, 13, 14 are respectively provided with the flow control valves V1, V2, V3 for adjusting the flow rate of the refrigerant flowing through each passage, and the refrigerant passage 15 is provided with the expansion valve E1 for expanding the refrigerant to be supplied to the motor 4. The expansion valve E1 functions to decompress the refrigerant from the pressure P1 to the pressure P2.

In addition, the refrigerant passage 17 is connected to the refrigerant passage 16 so that the refrigerant inside the refrigerant passage 16 is supplied from the refrigerant passage 17 to the second battery heat exchanger 6b. In the refrigerant passage 17, the expansion valve E2 for expanding the refrigerant is provided upstream of the second battery heat exchanger 6b, which causes the refrigerant decompressed by the expansion valve E2 to be supplied to the second battery heat exchanger 6b. The expansion valve E2 functions to decompress the refrigerant from the pressure P1 to the pressure P3. In addition, in the refrigerant passage 17, an internal heat exchanger (IHX) 6c having a known double-tube structure is provided downstream of the second battery heat exchanger 6b, and the downstream side thereof is further connected to the first compressor 1a of the compressor 1. The refrigerant having the pressure P3 decompressed by the above-mentioned expansion valve E2 is supplied to the first compressor 1a.

Furthermore, the refrigerant passage 16 branches into the refrigerant passage 18 and the refrigerant passage 20 at a position downstream of a connection point with the refrigerant passage 17. The refrigerant passage 18 is provided with the expansion valve E3 for expanding the refrigerant. The expansion valve E3 functions to decompress the refrigerant from the pressure P1 to the pressure P2. In addition, at a confluence C3 that is downstream of the expansion valve E3, the refrigerant passage 18 joins the refrigerant passage 15 that is provided with the motor 4 described above, and the refrigerant passages 15, 18 are connected to the refrigerant passage 19. The refrigerant passage 19 is connected between the first compressor 1a and the second compressor 1b of the compressor 1, and supplies the refrigerant having the pressure P2 decompressed by the expansion valve E1 and the expansion valve E3 to the second compressor 1b. On the other hand, the refrigerant passage 20 is connected, at a confluence C4 on its downstream side, to the refrigerant passage 11 between the compressor 1 and the cascade heat exchanger 2. The refrigerant passage 20 is provided with the pressure feeder 23 and an internal heat exchanger (IHX) 24 having a known double-tube structure. Such a refrigerant passage 20 enables the pressure feeder 23 to supply the refrigerant from the above-mentioned refrigerant passage 16 to the cascade heat exchanger 2, without passing the refrigerant through the compressor 1 (that is, bypassing the compressor 1).

Note that the refrigerant passage 17 corresponds to the “first refrigerant passage” in the one or more embodiments, and the refrigerant passages 18 and 19 correspond to the “second refrigerant passage” in the one or more embodiments. In addition, the expansion valve E2 corresponds to the “first expansion valve” in the one or more embodiments, and the expansion valve E3 corresponds to the “second expansion valve” in the one or more embodiments.

Next, the second heat cycle circuit 100b of the cooling system 100 is a high-temperature circuit that circulates the refrigerant such as propane or a fluorine-based refrigerant as described above, and includes, in addition to the outside air heat exchanger 30 that exchanges heat with the outside air, a refrigerant passage 31 through which the refrigerant flows, a pressure feeder 32 that pressure-feeds the refrigerant, and an expansion valve 33 that expands the refrigerant. In the cooling system 100 according to the one or more embodiments, providing such a second heat cycle circuit 100b separately from the first heat cycle circuit 100a improves the efficiency of the entire system of the first heat cycle circuit 100a, in other words, reduces the work of the compressor 1.

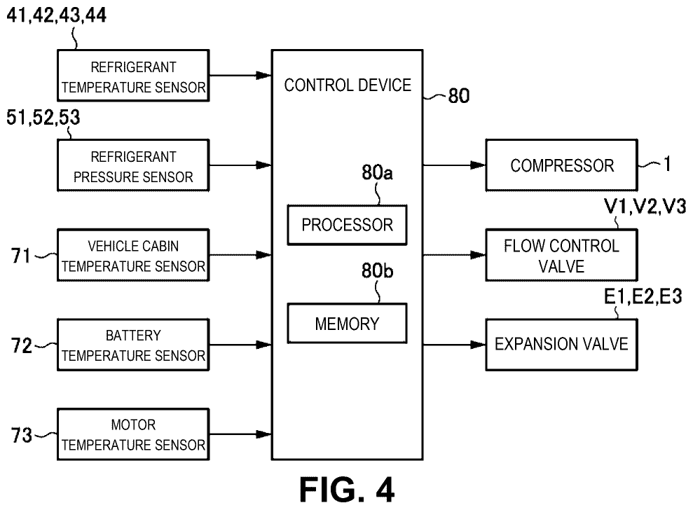

Next, the electrical configuration of the cooling system 100 according to the one or more embodiments will be described with reference to FIG. 4 in addition to FIG. 2. FIG. 4 is a block diagram showing the electrical configuration of the cooling system 100 according to the one or more embodiments.

As shown in FIG. 4, the cooling system 100 includes a control device 80 that is configured to perform various types of control in the system. The control device 80 is composed of a computer including one or more processors 80a (typically, CPUs), and a memory 80b such as a ROM or a RAM that stores various programs (including a basic control program such as an OS and an application program that is started on the OS to implement a specific function) that are interpreted and executed on the processor 80a, and various data. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

In addition, the cooling system 100 includes refrigerant temperature sensors 41, 42, 43, 44 that detect the temperature of the refrigerant and refrigerant pressure sensors 51, 52, 53 that detect the pressure of the refrigerant, the refrigerant temperature sensors 41, 42, 43, 44 and the refrigerant pressure sensors 51, 52, 53 being provided in the first heat cycle circuit 100a (refer to FIG. 2), a vehicle cabin temperature sensor 71 that detects the temperature of a vehicle cabin (cabin), a battery temperature sensor 72 that detects the temperature of the battery 6, and a motor temperature sensor 73 that detects the temperature of the motor 4. Specifically, as shown in FIG. 2, the refrigerant temperature sensor 41 is provided on the refrigerant passage 11 between the compressor 1 and the cascade heat exchanger 2 (specifically, upstream of the confluence C4 of the refrigerant passage 11 and the refrigerant passage 20), the refrigerant temperature sensor 42 is provided at the confluence C2 of the refrigerant passage 14 and the refrigerant passage 16, the refrigerant temperature sensor 43 is provided at the confluence C3 of the refrigerant passage 15 and the refrigerant passage 18, and the refrigerant temperature sensor 44 is provided on the refrigerant passage 17 downstream of the second battery heat exchanger 6b and the IHX 6c. In addition, the refrigerant pressure sensor 51 is provided on the refrigerant passage 11 downstream of the cascade heat exchanger 2, the refrigerant pressure sensor 52 is provided on the refrigerant passage 15 downstream of the motor 4, and the refrigerant pressure sensor 53 is provided on the refrigerant passage 17 downstream of the second battery heat exchanger 6b and the IHX 6c.

The control device 80 supplies control signals to the compressor 1, the flow control valves V1, V2, V3, and the expansion valves E1, E2, E3 on the basis of detection signals from the above-mentioned sensors 41 to 44, 51 to 53, 71 to 73, thereby controlling these. In particular, in the one or more embodiments, the control device 80 controls the expansion valve E2 and the expansion valve E3, so as to restrain the refrigerant from becoming high temperature by being raised in pressure by the compressor 1 (details will be described further below).

### [Control Method]

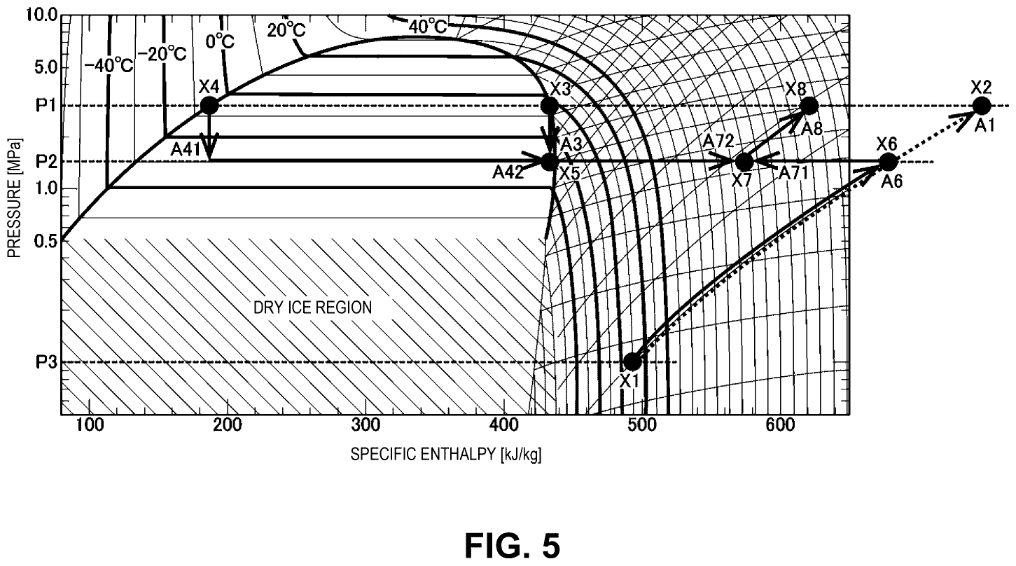

Next, control performed by the control device 80 in the one or more embodiments will be described. First, a basic concept of the control according to the one or more embodiments will be described with reference to FIG. 5. FIG. 5 shows the specific enthalpy (the enthalpy per unit mass) of the CO₂ refrigerant on the horizontal axis and shows the pressure of the CO₂ refrigerant on the vertical axis. Specifically, FIG. 5 shows a part of the Mollier diagram (p-h diagram) obtained by the first heat cycle circuit 100a of the cooling system 100. Note that the specific enthalpy illustrated in FIG. 5 is defined relative to a point on the liquid side of the saturated vapor pressure line at 0° C. (200 KJ/kg).

As described above, in the one or more embodiments, in the second battery heat exchanger 6b, the refrigerant is passed around the plurality of cells 62 inside the battery pack 61 to directly cool the plurality of cells 62 using the refrigerant (FIG. 3(b)), but, in this case, it is not desirable to supply the refrigerant that has been brought to high pressure by being compressed by the compressor 1 as it is to the second battery heat exchanger 6b because the pressure resistance of the battery pack 61 is relatively low. Thus, in the one or more embodiments, the refrigerant that has been brought to high pressure by being compressed by the compressor 1 is largely decompressed (from the pressure P1 to the pressure P3) by the expansion valve E2 that is provided upstream of the second battery heat exchanger 6b in the refrigerant passage 17 and supplied to the second battery heat exchanger 6b.

Then, the refrigerant supplied to the second battery heat exchanger 6b as described above is returned to the compressor 1 and raised in pressure. At this time, as shown in FIG. 5, the refrigerant changes from a state indicated by point X1 to a state indicated by point X2 (arrow A1). Here, a case in which the compressor 1 raises the pressure of the refrigerant in one stage is described as an example. In this case, the compressor 1 largely raises the pressure of the refrigerant having a considerably low pressure in one stage (from the pressure P3 to the pressure P1). For example, when the pressure P1 is approximately 3 MPa and the pressure P3 is approximately 0.1 MPa, there is a 30-fold pressure difference between before and after the compressor 1. As a result, the refrigerant discharged from the compressor 1 becomes high temperature (for example, equal to or higher than 280° C.). This causes oil in the refrigerant to stop functioning, thereby causing seizure of a sliding surface, a reduction in the sealability, or deterioration of the oil.

Thus, in the one or more embodiments, the compressor 1 is configured to raise the pressure of the refrigerant in two stages using the first and second compressors 1a, 1b, and while the first compressor 1a on the upstream side is supplied with the refrigerant having a low pressure (the pressure P3), the second compressor 1b on the downstream side is supplied with the refrigerant that has a medium pressure (the pressure P2>the pressure P3) and is in a relatively low enthalpy state, thereby lowering the temperature of the refrigerant discharged from the compressor 1 (the second compressor 1b).

Such control according to the one or more embodiments will be more specifically described with reference to FIG. 5. First, in the first heat cycle circuit 100a of the cooling system 100, the refrigerant supplied from the refrigerant passage 11 to the refrigerant passage 18 through the refrigerant passages 12, 13, 14 and the refrigerant passage 16 is in a state indicated by point X3, and changes as indicated by arrow A3 due to decompression of the expansion valve E3 on the refrigerant passage 18 (from the pressure P1 to the pressure P2). In addition, the refrigerant supplied from the refrigerant passage 11 to the refrigerant passage 15 changes as indicated by arrow A41, A42 from a state indicated by point X4 due to decompression of the expansion valve E3 on the refrigerant passage 15 (from the pressure P1 to the pressure P2) and heat exchange in the motor 4. The refrigerant that has flowed through the refrigerant passage 18 and the refrigerant passage 15 in this manner join at the confluence C3 and flows into the refrigerant passage 19 (in this case, becomes a state indicated by point X5), and is supplied from the refrigerant passage 19 to the second compressor 1b. On the other hand, in the refrigerant passage 17 that is provided with the second battery heat exchanger 6b, as described above, the refrigerant becomes the state indicated by point X1 due to the decompression of the expansion valve E2 (from the pressure P1 to the pressure P3) and heat exchange in the second battery heat exchanger 6b, and the refrigerant then changes from the state indicated by point X1 to a state indicated by point X6 by being raised in pressure by the first compressor 1a, as indicated by arrow A6.

The refrigerant raised in pressure by the first compressor 1a, that is, the refrigerant discharged from the first compressor 1a joins the refrigerant supplied from the refrigerant passage 19 to the second compressor 1b as described above between the first compressor 1a and the second compressor 1b. At this time, the refrigerant in the state indicated by point X6 from the first compressor 1a changes as indicated by arrow A71, and the refrigerant in the state indicated by point X5 from the refrigerant passage 19 changes as indicated by arrow A72, and, as a result, the joined refrigerant becomes a state indicated by point X7. In this case, the refrigerant (point X5) in a relatively low enthalpy state from the refrigerant passage 19 is mixed with the refrigerant (point X6) that has become a relatively high enthalpy state by being raised in pressure by the first compressor 1a, so that the refrigerant (point X7) with a reduced specific enthalpy is supplied to the second compressor 1b. Then, the refrigerant in the state indicated by point X7 supplied to the second compressor 1b changes to a state indicated by point X8 as indicated by arrow A8 by being raised in pressure by the second compressor 1b. In the state indicated by point X8, the specific enthalpy of the refrigerant has largely decreased compared to the state indicated by point X2 in the case of raising the pressure of the refrigerant in one stage (arrow A1) as described above, that is, the temperature of the refrigerant has largely decreased. Thus, according to the one or more embodiments, the temperature of the refrigerant discharged from the compressor 1 (the second compressor 1b) can be lowered.

Here, there is a trade-off that, when the amount of the refrigerant that is decompressed in the expansion valve E3 on the refrigerant passage 19 is large, since the work of compressing the decompressed refrigerant occurs, the compressor work at the compressor 1 increases, that is, the efficiency of the cooling system 100 (in particular, the first heat cycle circuit 100a) is reduced. Thus, it can be said that it is not desirable to unnecessarily increase the amount of the refrigerant supplied from the refrigerant passage 19 to the second compressor 1b. On the other hand, the state of the specific enthalpy at the confluence C3 (point X5) is influenced by the cooling requirement of the motor 4 and the like. This influence changes the specific enthalpy of the refrigerant supplied from the refrigerant passage 19 to the second compressor 1b (point X7), and the specific enthalpy of the refrigerant discharged from the second compressor 1b (point X8), that is, the temperature of the refrigerant fluctuates.

Thus, in the one or more embodiments, the control device 80 monitors the temperature of the refrigerant discharged from the second compressor 1b and controls the expansion valve E3 on the refrigerant passage 18 so as to adjust the amount of the refrigerant supplied from the refrigerant passage 19 to the second compressor 1b. Specifically, in the one or more embodiments, when the temperature of the refrigerant discharged from the second compressor 1b is equal to or higher than a predetermined temperature (e.g., 180° C.), the control device 80 makes the temperature of the refrigerant lower than the predetermined temperature by performing control to increase the opening degree of the expansion valve E3 (in other words, the opening degree of the expansion valve E3 is not increased when the temperature of the refrigerant is lower than the predetermined temperature). Accordingly, it is possible to appropriately lower the temperature of the refrigerant discharged from the second compressor 1b while restraining the reduction in the efficiency of the cooling system 100 (in particular, the first heat cycle circuit 100a).

In addition, in the one or more embodiments, when the temperature of the refrigerant discharged from the second compressor 1b is equal to or higher than the predetermined temperature and the expansion valve E3 is in a fully open state, the control device 80 performs control to reduce the opening degree of the expansion valve E2 on the refrigerant passage 17. Accordingly, by narrowing the expansion valve E2 on the refrigerant passage 17, it is possible to increase the amount of the refrigerant flowing through the refrigerant passages 18, 19 and ensure the amount of the refrigerant supplied from the refrigerant passage 19 to the second compressor 1b. Thus, according to the one or more embodiments, even when the expansion valve E3 becomes a fully open state, it is possible to appropriately lower the temperature of the refrigerant discharged from the second compressor 1b.

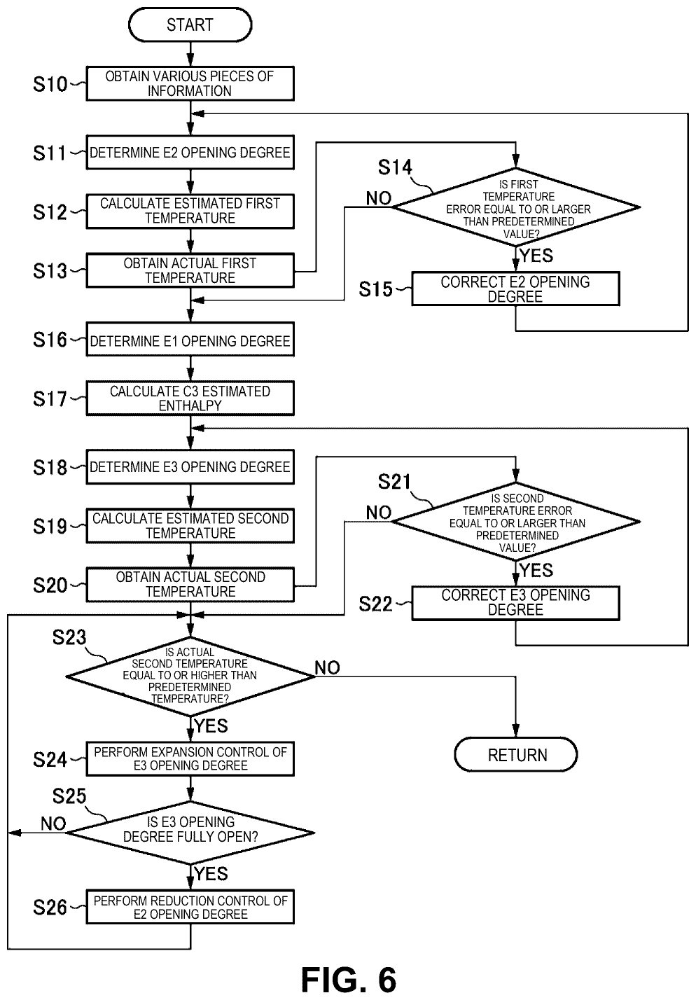

Next, a flowchart showing the specific control according to the one or more embodiments will be described with reference to FIG. 6. This flow is repeatedly executed by the control device 80 at a predetermined cycle. Specifically, the processor 80a in the control device 80 reads a program stored in the memory 80b and executes the program to implement the control related to this flow.

First, in step S10, the control device 80 obtains various pieces of information such as detection values detected by the sensors 41 to 44, 51 to 53, 71 to 73 (FIG. 4) described above.

Next, in step S11, the control device 80 determines the opening degree of the expansion valve E2 on the refrigerant passage 17 (hereinbelow, referred to as the “E2 opening degree” as appropriate) in accordance with to the cooling requirement of the battery 6. In this case, the control device 80 determines the E2 opening degree on the basis of the current temperature of the battery 6 detected by the battery temperature sensor 72.

Next, in step S12, the control device 80 obtains a temperature on the downstream side of the second battery heat exchanger 6b in the refrigerant passage 17 (hereinbelow, referred to as the “estimated first temperature” as appropriate) on the basis of the E2 opening degree determined in step S11 and the like. For example, the control device 80 obtains the estimated first temperature using a map, a calculation formula, or the like that is previously defined from the E2 opening degree and the like.

Next, in step S13, the control device 80 obtains the temperature of the refrigerant (hereinbelow, referred to as the “actual first temperature” as appropriate) detected by the refrigerant temperature sensor 44 that is provided on the refrigerant passage 17 downstream of the second battery heat exchanger 6b.

Next, in step S14, the control device 80 determines whether the difference between the estimated first temperature obtained in step S12 and the actual first temperature obtained in step S13 (hereinbelow, referred to as the “first temperature error” as appropriate) is equal to or larger than a predetermined value. As a result, when the first temperature error is determined to be equal to or larger than the predetermined value (step S14: Yes), the control device 80 proceeds to step S15, corrects the E2 opening degree on the basis of the first temperature error, and returns to step S11. In step S11, the control device 80 determines the E2 opening degree corrected in step S15 as the opening degree to be applied. On the other hand, when the first temperature error is not determined to be equal to or larger than predetermined value (step S14: No), that is, when the first temperature error is less than the predetermined value, the control device 80 proceeds to step S16 without performing the process of step S15 as described above.

Next, in step S16, the control device 80 determines the opening degree of the expansion valve E1 on the refrigerant passage 15 (hereinbelow, referred to as the “E1 opening degree” as appropriate) in accordance with the cooling requirement of the motor 4. In this case, the control device 80 determines the E1 opening degree on the basis of the current temperature of the motor 4 detected by the motor temperature sensor 73.

Next, in step S17, the control device 80 obtains the specific enthalpy of the refrigerant at the confluence C3 of the refrigerant passage 15 and the refrigerant passage 18 (hereinbelow, referred to as the “C3 estimated enthalpy” as appropriate, note that the C3 estimated enthalpy corresponds to the specific enthalpy at point X5 in FIG. 5) on the basis of the E1 opening degree determined in step S16 and the like. For example, the control device 80 obtains the C3 estimated enthalpy using a map, a calculation formula, or the like that is previously defined from the E1 opening degree and the like.

Next, in step S18, the control device 80 determines the opening degree of the expansion valve E3 on the refrigerant passage 18 (hereinbelow, referred to as the “E3 opening degree” as appropriate) on the basis of the actual first temperature obtained in step S13 and the C₃ estimated enthalpy obtained in step S17. For example, the control device 80 obtains a flow rate from the refrigerant passage 18 that is required to set the temperature of the refrigerant discharged from the second compressor 1b to be lower than the predetermined temperature on the basis of the actual first temperature on the downstream side of the second battery heat exchanger 6b and the C₃ estimated enthalpy at the confluence C3, and determines the E3 opening degree that achieves this flow rate.

Next, in step S19, the control device 80 obtains the temperature of the refrigerant discharged from the second compressor 1b (hereinbelow, referred to as the “estimated second temperature” as appropriate) on the basis of the E3 opening degree determined in step S18 and the like. For example, the control device 80 obtains the estimated second temperature using a map, a calculation formula, or the like that is previously defined from the E3 opening degree and the like.

Next, in step S20, the control device 80 obtains the temperature of the refrigerant (hereinbelow, referred to as the “actual second temperature” as appropriate) detected by the refrigerant temperature sensor 41 that is provided on the refrigerant passage 11 between the compressor 1 and the cascade heat exchanger 2.

Next, in step S21, the control device 80 determines whether the difference between the estimated second temperature obtained in step S19 and the actual second temperature obtained in step S20 (hereinbelow, referred to as the “second temperature error” as appropriate) is equal to or larger than a predetermined value. As a result, when the second temperature error is determined to be equal to or larger than the predetermined value (step S21: Yes), the control device 80 proceeds to step S22, corrects the E3 opening degree on the basis of the second temperature error, and returns to step S18. In step S18, the control device 80 determines the E3 opening degree corrected in step S22 as the opening degree to be applied. On the other hand, when the second temperature error is not determined to be equal to or larger than predetermined value (step S21: No), that is, when the second temperature error is less than the predetermined value, the control device 80 proceeds to step S23 without performing the process of step S22 as described above.

Next, in step S23, the control device 80 determines whether the actual second temperature obtained in step S20 is equal to or higher than a predetermined temperature (e.g., 180° C.). As a result, when the actual second temperature is determined to be equal to or higher than the predetermined temperature (step S23: Yes), the control device 80 proceeds to step S24, and performs control (expansion control) to increase the E3 opening degree of the expansion valve E3 in order to increase the amount of the refrigerant supplied from the refrigerant passages 18, 19 to the second compressor 1b.

Then, the control device 80 proceeds to step S25 and determines whether the E3 opening degree is fully open, that is, whether the E3 opening degree is already in a fully open state due to the expansion control of the expansion valve E3. As a result, when the E3 opening degree is determined to be fully open (step S25: Yes), the control device 80 proceeds to step S26 and performs control (reduction control) to reduce the E2 opening degree of the expansion valve E2. In this case, by narrowing the expansion valve E2 on the refrigerant passage 17, it is possible to increase the amount of the refrigerant flowing through the refrigerant passages 18, 19 and ensure the amount of the refrigerant supplied from the refrigerant passage 19 to the second compressor 1b.

Then, the control device 80 returns to step S23 and performs the processes of step S23 and the subsequent steps again. Note that, before the control device 80 performs the determination of the actual second temperature in step S23, the control device 80 obtains the temperature (actual second temperature) detected by the refrigerant temperature sensor 41 again in the same manner as in step S20 (the same applies hereinafter). In addition, when the E2 opening degree becomes fully closed by the reduction control of the expansion valve E2 (step S26) by repeating steps S23 to S26, the process shown in the flow of FIG. 6 may be finished.

On the other hand, when the actual second temperature is not determined to be equal to or higher than the predetermined temperature in step S23 (step S23: No), since the actual second temperature is lower than the predetermined temperature in this case, the control device 80 finishes the process shown in the flow of FIG. 6. In addition, when the E3 opening degree is not determined to be fully open in step S25 (step S25: No), the control device 80 returns to step S23.

Note that, although the process is performed using the specific enthalpy in the flow described above, the process of the above flow may be performed using a superheat degree that is defined by the specific enthalpy and the saturated vapor line, instead of using the specific enthalpy.

### Action and Effects

Next, the action and effects of the cooling system 100 according to the one or more embodiments will be described. In the one or more embodiments, the cooling system 100 that performs cooling inside the vehicle 200 by circulating the refrigerant containing CO₂ (CO₂ refrigerant) includes the compressor 1 that includes the first compressor 1a and the second compressor 1b provided downstream of the first compressor 1a and is configured to compress the refrigerant in two stages using the first and second compressors 1a, 1b, the cascade heat exchanger 2 for cooling the refrigerant compressed by the compressor 1, the air conditioning heat exchanger 5a and the first battery heat exchanger 6a that use the refrigerant cooled by the cascade heat exchanger 2, the refrigerant passage 17 for supplying the refrigerant to the battery 6 to cool the battery 6 using the refrigerant cooled by the cascade heat exchanger 2 and supplying the refrigerant that has been used for cooling in the battery 6 to the first compressor 1a, the refrigerant passages 18, 19 for supplying the refrigerant that has been used for cooling in the air conditioning heat exchanger 5a and the first battery heat exchanger 6a to the second compressor 1b, the expansion valve E2 for expanding the refrigerant, the expansion valve E2 being provided on the refrigerant passage 17, the expansion valve E3 for expanding the refrigerant, the expansion valve E3 being provided on the refrigerant passage 18, and the control device 80 configured to control at least the expansion valves E2, E3, and the control device 80 performs control to increase the opening degree of the expansion valve E3 when the temperature of the refrigerant discharged from the second compressor 1b is equal to or higher than the predetermined temperature.

According to the one or more embodiments as described above, the compressor 1 is configured to raise the pressure of the refrigerant in two stages using the first and second compressors 1a, 1b, and, while the first compressor 1a on the upstream side is supplied with the refrigerant decompressed by the expansion valve E2, the second compressor 1b on the downstream side is supplied with the refrigerant that is a mixture of the refrigerant discharged from the first compressor 1a with the refrigerant in a relatively low enthalpy state decompressed by the expansion valve E3 (that is, the refrigerant having a lower enthalpy than the refrigerant that has been raised in pressure by the first compressor 1a described above), thereby making it possible to restrain the refrigerant that has been raised in pressure by the second compressor 1b from becoming high temperature. In particular, in the one or more embodiments, when the temperature of the refrigerant discharged from the second compressor 1b is equal to or higher than the predetermined temperature, the temperature of the refrigerant is made lower than the predetermined temperature by performing control to increase the opening degree of the expansion valve E3 (in other words, the opening degree of the expansion valve E3 is not increased when the temperature of the refrigerant is lower than the predetermined temperature) to increase the amount of the refrigerant supplied from the refrigerant passage 19 to the second compressor 1b. Accordingly, it is possible to appropriately lower the temperature of the refrigerant discharged from the second compressor 1b while restraining the reduction in the efficiency of the cooling system 100 (in particular, the first heat cycle circuit 100a). As a result, it is possible to maintain the function of oil in the refrigerant and restrain deterioration of the oil.

In addition, according to the one or more embodiments, when the temperature of the refrigerant discharged from the second compressor 1b is equal to or higher than the predetermined temperature and the expansion valve E3 is fully open, the control device 80 performs control to reduce the opening degree of the expansion valve E2. Accordingly, by narrowing the expansion valve E2 on the refrigerant passage 17, it is possible to increase the amount of the refrigerant flowing through the refrigerant passages 18, 19 and ensure the amount of the refrigerant supplied from the refrigerant passage 19 to the second compressor 1b. Thus, according to the one or more embodiments, it is possible to appropriately lower the temperature of the refrigerant discharged from the second compressor 1b even when the expansion valve E3 becomes a fully open state.

In addition, according to the one or more embodiments, the cooling system 100 further includes the second battery heat exchanger 6b for directly cooling the plurality of cells 62 inside the battery 6 using the refrigerant by passing the refrigerant in the refrigerant passage 17 around the plurality of cells 62, and the second battery heat exchanger 6b is supplied with the refrigerant decompressed by the expansion valve E2. According to the one or more embodiments as described above, since the plurality of cells 62 are directly cooled using the refrigerant in the second battery heat exchanger 6b, it is possible to effectively cool the plurality of cells 62 of the battery 6. In this case, since it is not desirable to supply the high-pressure refrigerant from the compressor 1 as it is to the second battery heat exchanger 6b because the pressure resistance of the battery pack 61 and the like is relatively low, the refrigerant from the compressor 1 is decompressed by the expansion valve E2 and supplied to the second battery heat exchanger 6b in the one or more embodiments. Accordingly, it is possible to properly protect the inside of the battery 6 (such as the plurality of cells 62).

In addition, according to the one or more embodiments, as the heat exchanger that uses the refrigerant cooled by the cascade heat exchanger 2, the air conditioning heat exchanger 5a for performing air conditioning of the vehicle 200, and the first battery heat exchanger 6a that indirectly cools the plurality of cells 62 using the refrigerant by supplying the refrigerant to the outside of the battery pack 61 including the plurality of cells 62 in the battery 6 are used. According to the one or more embodiments as described above, it is possible to appropriately achieve both air conditioning of the vehicle 200 and cooling of the battery 6 using the refrigerant circulated in the cooling system 100. In particular, by using the first battery heat exchanger 6a that indirectly cools the plurality of cells 62 by supplying the refrigerant to the outside of the battery pack 61, it is possible to achieve relatively large heat exchange with the refrigerant.

In addition, according to the one or more embodiments, the cascade heat exchanger 2 is configured to perform heat exchange between the first heat cycle circuit 100a including at least the compressor 1, the air conditioning heat exchanger 5a, and the first battery heat exchanger 6a and the second heat cycle circuit 100b including the outside air heat exchanger 30 that exchanges heat with the outside air separately from the first heat cycle circuit 100a. Accordingly, by causing the first heat cycle circuit 100a to perform heat exchange (cascade heat exchange) with the second heat cycle circuit 100b that exchanges heat with the outside air, it is possible to improve the efficiency of the entire system of the first heat cycle circuit 100a, in other words, reduce the work of the compressor 1.

In addition, according to the one or more embodiments, the cooling system 100 further cools, using the refrigerant cooled by the cascade heat exchanger 2, the motor 4 that drives the vehicle 200 using electric power of the battery 6. Accordingly, it is possible to appropriately achieve cooling of various components inside the vehicle 200, such as the motor 4, using the refrigerant circulated in the cooling system 100.

In addition, according to the one or more embodiments, the refrigerant that has been used for cooling in the motor 4 is further supplied to the refrigerant passage 19. Accordingly, the refrigerant in a relatively low enthalpy state from the motor 4 can be supplied to the second compressor 1b. In this case, although the specific enthalpy of the refrigerant supplied from the refrigerant passage 19 to the second compressor 1b changes due to the cooling requirement of the motor 4 and the like, in the one or more embodiments, as described above, since the temperature of the refrigerant discharged from the second compressor 1b is monitored, and the opening degree of the expansion valve E3 is controlled in accordance with this temperature, the influence of the change in the specific enthalpy of the refrigerant caused by the cooling requirement of the motor 4 and the like can be reduced.

### Modifications

Although, in the embodiment described above, the cooling system 100 includes the first heat cycle circuit 100a and the second heat cycle circuit 100b, in another example, the cooling system 100 may include only the first heat cycle circuit 100a. In that case, the cascade heat exchanger 2 may be configured as the outside air heat exchanger. Note that, when the cooling system 100 includes the first heat cycle circuit 100a and the second heat cycle circuit 100b, although the system efficiency becomes high (that is, the work of the compressor 1 can be reduced), the configuration becomes complicated. Thus, when simplification of the configuration is prioritized over the system efficiency, the cooling system 100 preferably includes only the first heat cycle circuit 100a.

In addition, although, in the embodiment described above, the temperature of the battery 6 is detected by the battery temperature sensor 72, in another example, the temperature of the battery 6 may be estimated in accordance with the current value or the voltage value of the battery 6, the output requirements of the battery 6, the charging speed requirements of the battery 6, or the like. In still another example, the temperature of the battery 6 may be estimated on the basis of the temperature of the refrigerant detected by the refrigerant temperature sensor 44 that is provided on the refrigerant passage 17 downstream of the second battery heat exchanger 6b.

### REFERENCE SIGNS LIST

1 compressor
1a first compressor
1b second compressor
2 heat exchanger (cascade heat exchanger)
4 motor
5 air conditioner
5a air conditioning heat exchanger
6 battery
6a first battery heat exchanger
6b second battery heat exchanger
11 to 20 refrigerant passage
41, 42, 43, 44 refrigerant temperature sensor
51, 52, 53 refrigerant pressure sensor
61 battery pack
62 cell
80 control device
100 cooling system
100a first heat cycle circuit
100b second heat cycle circuit
200 vehicle
E1, E2, E3 expansion valve
V1, V2, V3 flow control valve

1. A cooling system that performs cooling inside a vehicle by circulating a refrigerant, the cooling system comprising:
a compressor including a first compressor and a second compressor provided downstream of the first compressor, the compressor being configured to compress the refrigerant in two stages using the first compressor and the second compressor, the refrigerant containing CO₂;
a first heat exchanger for cooling the refrigerant compressed by the compressor;
a second heat exchanger for cooling a predetermined cooling target inside the vehicle using the refrigerant cooled by the first heat exchanger;
a first refrigerant passage for supplying the refrigerant to a battery inside the vehicle to cool the battery using the refrigerant cooled by the first heat exchanger and supplying the refrigerant that has been used for cooling in the battery to the first compressor of the compressor;
a second refrigerant passage for supplying the refrigerant that has been used for cooling in the second heat exchanger to the second compressor of the compressor;
a first expansion valve for expanding the refrigerant, the first expansion valve being provided on the first refrigerant passage;
a second expansion valve for expanding the refrigerant, the second expansion valve being provided on the second refrigerant passage; and
processing circuitry configured to:
obtain a temperature of the refrigerant discharged from the second compressor of the compressor, and
perform control to increase an opening degree of the second expansion valve when the temperature is equal to or higher than a predetermined temperature.

2. The cooling system according to claim 1, wherein the processing circuitry is further configured to perform control to reduce an opening degree of the first expansion valve when the temperature of the refrigerant discharged from the second compressor is equal to or higher than the predetermined temperature and the second expansion valve is fully open.

3. The cooling system according to claim 1, further comprising a battery heat exchanger for directly cooling a plurality of cells inside the battery using the refrigerant by passing the refrigerant in the first refrigerant passage around the plurality of cells, wherein
the battery heat exchanger is supplied with the refrigerant decompressed by the first expansion valve.

4. The cooling system according to claim 2, further comprising a battery heat exchanger for directly cooling a plurality of cells inside the battery using the refrigerant by passing the refrigerant in the first refrigerant passage around the plurality of cells, wherein
the battery heat exchanger is supplied with the refrigerant decompressed by the first expansion valve.

5. The cooling system according to claim 1, wherein the second heat exchanger includes an air conditioning heat exchanger for performing air conditioning of the vehicle and/or a battery heat exchanger for indirectly cooling a plurality of cells of the battery using the refrigerant by supplying the refrigerant to outside of the battery.

6. The cooling system according to claim 2, wherein the second heat exchanger includes an air conditioning heat exchanger for performing air conditioning of the vehicle and/or a battery heat exchanger for indirectly cooling a plurality of cells of the battery using the refrigerant by supplying the refrigerant to outside of the battery.

7. The cooling system according to claim 1, wherein the first heat exchanger is a cascade heat exchanger that performs heat exchange between a first heat cycle circuit and a second heat cycle circuit,
the first heat cycle circuit includes at least the compressor, the second heat exchanger, the first and second refrigerant passages, and the first and second expansion valves, and
the second heat cycle circuit includes an outside air heat exchanger that exchanges heat with outside air separately from the first heat cycle circuit.

8. The cooling system according to claim 2, wherein the first heat exchanger is a cascade heat exchanger that performs heat exchange between a first heat cycle circuit and a second heat cycle circuit,
the first heat cycle circuit includes at least the compressor, the second heat exchanger, the first and second refrigerant passages, and the first and second expansion valves, and
the second heat cycle circuit includes an outside air heat exchanger that exchanges heat with outside air separately from the first heat cycle circuit.

9. The cooling system according to claim 1, wherein the cooling system is configured to further cool, using the refrigerant cooled by the first heat exchanger, a motor that drives the vehicle using electric power of the battery.

10. The cooling system according to claim 2, wherein the cooling system is configured to further cool, using the refrigerant cooled by the first heat exchanger, a motor that drives the vehicle using electric power of the battery.

11. The cooling system according to claim 9, wherein the refrigerant that has been used for cooling in the motor is further supplied to the second refrigerant passage.

12. The cooling system according to claim 10, wherein the refrigerant that has been used for cooling in the motor is further supplied to the second refrigerant passage.

13. A vehicle including:
a battery;
a motor that drives the vehicle using electric power of the battery; and
a cooling system that performs cooling inside the vehicle by circulating a refrigerant containing CO₂, the cooling system comprising:
a compressor including a first compressor and a second compressor provided downstream of the first compressor, the compressor being configured to compress the refrigerant in two stages using the first compressor and the second compressor, the refrigerant containing CO₂;
a first heat exchanger for cooling the refrigerant compressed by the compressor;
a second heat exchanger for cooling a predetermined cooling target inside the vehicle using the refrigerant cooled by the first heat exchanger;
a first refrigerant passage for supplying the refrigerant to the battery inside the vehicle to cool the battery using the refrigerant cooled by the first heat exchanger and supplying the refrigerant that has been used for cooling in the battery to the first compressor of the compressor;
a second refrigerant passage for supplying the refrigerant that has been used for cooling in the second heat exchanger to the second compressor of the compressor;
a first expansion valve for expanding the refrigerant, the first expansion valve being provided on the first refrigerant passage;
a second expansion valve for expanding the refrigerant, the second expansion valve being provided on the second refrigerant passage; and
processing circuitry configured to:
obtain a temperature of the refrigerant discharged from the second compressor of the compressor, and
perform control to increase an opening degree of the second expansion valve when the temperature is equal to or higher than a predetermined temperature.

14. The vehicle according to claim 13, wherein the processing circuitry is further configured to perform control to reduce an opening degree of the first expansion valve when the temperature of the refrigerant discharged from the second compressor is equal to or higher than the predetermined temperature and the second expansion valve is fully open.

15. The vehicle according to claim 13, further comprising a battery heat exchanger for directly cooling a plurality of cells inside the battery using the refrigerant by passing the refrigerant in the first refrigerant passage around the plurality of cells, wherein
the battery heat exchanger is supplied with the refrigerant decompressed by the first expansion valve.

16. The vehicle according to claim 13, wherein the second heat exchanger includes an air conditioning heat exchanger for performing air conditioning of the vehicle and/or a battery heat exchanger for indirectly cooling a plurality of cells of the battery using the refrigerant by supplying the refrigerant to outside of the battery.

17. The vehicle according to claim 13, wherein the first heat exchanger is a cascade heat exchanger that performs heat exchange between a first heat cycle circuit and a second heat cycle circuit,
the first heat cycle circuit includes at least the compressor, the second heat exchanger, the first and second refrigerant passages, and the first and second expansion valves, and
the second heat cycle circuit includes an outside air heat exchanger that exchanges heat with outside air separately from the first heat cycle circuit.

18. The vehicle according to claim 13, wherein the cooling system is configured to further cool, using the refrigerant cooled by the first heat exchanger, a motor that drives the vehicle using electric power of the battery.

19. A method for performing cooling of a vehicle, comprising:
compressing, by a compressor including a first compressor and a second compressor, a refrigerant containing CO₂ in two stages, the second compressor being provided downstream of the first compressor;
cooling, by a first heat exchanger, the refrigerant compressed by the compressor;
cooling, by a second heat exchanger, a predetermined cooling target inside the vehicle using the refrigerant cooled by the first heat exchanger;
supplying, by a first refrigerant passage, the refrigerant to a battery inside the vehicle to cool the battery using the refrigerant cooled by the first heat exchanger and supplying the refrigerant that has been used for cooling in the battery to the first compressor of the compressor;
supplying, by a second refrigerant passage, the refrigerant that has been used for cooling in the second heat exchanger to the second compressor of the compressor;
expanding, by a first expansion valve, the refrigerant, the first expansion valve being provided on the first refrigerant passage;
expanding, by a second expansion valve, the refrigerant, the second expansion valve being provided on the second refrigerant passage; and
by processing circuitry:
obtaining a temperature of the refrigerant discharged from the second compressor of the compressor; and
performing control to increase an opening degree of the second expansion valve when the temperature is equal to or higher than a predetermined temperature.

20. The method according to claim 19, further comprising:
by the processing circuitry, performing control to reduce an opening degree of the first expansion valve when the temperature of the refrigerant discharged from the second compressor is equal to or higher than the predetermined temperature and the second expansion valve is fully open.
